(19) United States
(12) Patent Application Publication
(10) Pub. No.: US 2013/0249706 A1
(43) Pub. Date: Sep. 26, 2013

(54) ELECTRIC SERVICE SYSTEM AND METHOD FOR PROVIDING ELECTRIC SERVICE

(71) Applicants: Chin-Tay Shih, Hsinchu (TW); Hua-chun Hsieh, Hsinchu (TW)

(72) Inventors: Chin-Tay Shih, Hsinchu (TW); Hua-chun Hsieh, Hsinchu (TW)

(73) Assignee: NATIONAL TSING HUA UNIVERSITY, Hsinchu (TW)

(21) Appl. No.: 13/535,791

(22) Filed: Jun. 28, 2012

(30) Foreign Application Priority Data
Mar. 23, 2012 (TW) 101110024

(51) Int. Cl. G08C 19/00

(52) U.S. Cl. 340/870.02

(57) ABSTRACT

An electric service system includes an electric meter and an electric service platform. The electric meter can be used for obtaining the electric record of the client terminal. The electric service platform is connected to the electric meter and the server terminal so as to receive and analyze the electric record from the electric meter to obtain an electric information, and then offer the server terminal at least one of the electric record and the electric information. The server terminal provides the service via the electric service system according to the electric record or the electric information. Accordingly, the electric service system enables the server terminal to provide customized service for the client terminal according to the electric information of the client terminal.

### BACKGROUND OF THE INVENTION

1. Field of the Invention

The present invention relates to an electric service system and method for providing electric service, and more particularly, to an electric service system and a method for providing electric service which can provide customized service for the client terminal according to the electric information.

2. Description of the Prior Art

In general, the domestic electricity consumption is calculated by an electric meter; therefore it is difficult to know the power consumption of each electric appliance. That is to say, when someone got a high electricity bill, he/she cannot find out which one of electric appliances has high power consumption. Additionally, when an electric appliance is too old to keep its power consumption in a normal range, it is also hard to find out the sticking point of problem.

In the prior art, an intelligent electric meter is used for providing detailed information about electricity consumption. For example, Taiwan published patent no. M416788 discloses a display device for electricity management, which can sense magnitude of voltage and current value of an electrical equipment, and measure the service power and required power so as to inform users of the service condition of the electrical equipment.

Although the intelligent electric meter s exemplary in this regard, there are some inconveniences. When the power consumption of electrical equipment exceeds the power limit and guarantees, the user still needs to repair or replace the electrical equipment. Furthermore, in consideration of economy, the intelligent electric meter cannot be generally applied or accepted in general household appliance.

By the same token, the electrical equipment supplier cannot further to provide maintenance service for the customers forwardly. On the other hand, when user finds out there is an electrical equipment needed to be repaired or replaced, the electrical equipment has been malfunctioned already in most cases. The malfunction may cause the electrical equipments to be unavailable or, the electrical equipments may be broken and self-ignited or, even worse, cause serious injury, such as conflagration or explosion.

### SUMMARY OF THE INVENTION

Therefore, a scope of the invention is to provide an electric service system for improving the problems of the prior art.

According to an embodiment of the invention, the electric service system for a server terminal to provide a service item for a client terminal comprises an electric meter and an electric service platform. The electric meter is configured on the client terminal and connected to at least one electric appliance, and used for obtaining an electric record of the at least one electric appliance; and the electric service platform is connected to the electric meter and the server terminal so as to receive and analyze the electric record from the electric meter to obtain an electric information, and then offer the server terminal at least one of the electric record and the electric information. Therefore, the server terminal can provide various service items for client terminal through the electric service system, according to the electric record and the electric information.

In the embodiment, the electric service platform comprises a recognition unit, a characterization database, and an electricity record database. The recognition unit connected to the electric meter for receiving the electric record, and further recognizes the at least one electric appliance according to the electric record and a characterization data; the characterization database is connected to the recognition unit, and used for providing the characterization data; and the electricity record database is connected to at least one of the electric meter and the recognition unit, used for storing the electric record and the recognition results of the at least one electric appliance.

Furthermore, another scope of the invention is to provide a method for providing electric service which enables the server terminal to provide customized service for the client terminal according to the electric information.

According to an embodiment, the method for providing electric service comprises following steps: first, obtaining an electric record of at least one electric appliance from a client terminal through an electric meter; second, receiving and analyzing the electric record from the electric meter to obtain an electric information on an electric service platform; subsequently, receiving at least one of the electric record and the electric information from the electric service platform to a server terminal, and transmitting a service item back to the electric service platform; lastly, providing the service item for the client terminal.

In this embodiment, the step of receiving and analyzing the electric record further comprises following substeps: first, receiving the electric record of client terminal from the electric meter by a recognition unit; next, recognizing at least one electric appliance according to an electric record and a characterization data by a recognition unit of the electric service platform; and then, storing the electric information in an electricity record database of the electric service platform. Wherein, the electric information comprises the electric record and the recognition results of the electric appliances.

Many other advantages and features of the present invention will be further understood by the detailed description and the accompanying sheet of drawings.

### BRIEF DESCRIPTION OF THE APPENDED DRAWINGS

FIG. 1 is a schematic diagram illustrating an electric service system according to an embodiment of the invention.

FIG. 2 is a schematic diagram illustrating an electric service platform according to the embodiment of FIG. 1.

FIG. 3 is a flowchart illustrating a method for providing electric service according to another embodiment of the invention.

FIG. 4 is a flowchart illustrating the detailed steps for obtaining the electric information from the electric service platform according to the method for providing electric service of FIG. 3.

To facilitate understanding, identical reference numerals have been used, where possible to designate identical elements that are common to the figures.

### DETAILED DESCRIPTION OF THE INVENTION

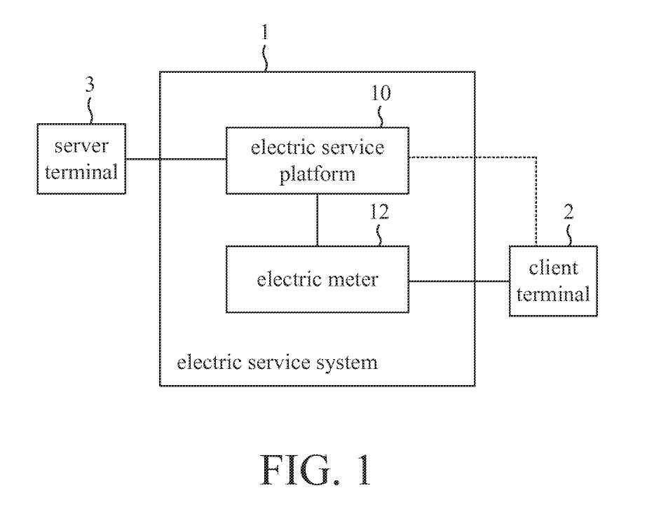

Please refer to FIG. 1. FIG. 1 is a schematic diagram illustrating an electric service system according to an embodiment of the invention. As shown in FIG. 1, the electric service system 1 comprises an electric meter 12 and an electric service platform 10. Wherein, the electric service platform 10 is connected to the electric meter 12 and the server terminal 3. In actual application, the electric service platform 10 can be connected to the electric meter 12 and the server terminal 3 through cable network or wireless network, but it is not limited to this form,

In the embodiment, the electric meter 12 can be used for sensing and obtaining an electric record of electric appliances from client terminal 2, and then, the electric service platform 10 can receive and analyze the electric record from the electric meter 12 to obtain an electric information. Following this, the electric service platform 10 can offer the server terminal 3 the electric record and the electric information, and hence, the server terminal 3 can provide a corresponding service item in accordance with the electric information. In actual application, the electric information can be the analysis result of the electric record which is received from the electric meter 12, or the analysis result of cross-comparison between the real-time and the historical electric records, but it is not limited to the description.

The client terminal 2 can be a general household in actual application, and the server terminal 3 can be an electrical equipment supplier. For example, an electric meter 12 senses and obtains an electric record of certain electric appliances from a household, such as washing machine, television, refrigerator, or air conditioner. After analyzing the electric record by the electric service platform 10, the analysis result is transmitted to an electrical equipment supplier. Therefore, the electrical equipment supplier can diagnose which electric appliances are malfunctioned and need to be inspected or repaired almost immediately, and further to provide maintenance service for customers forwardly. To be noticed, the present invention is not limited to the embodiment described herein.

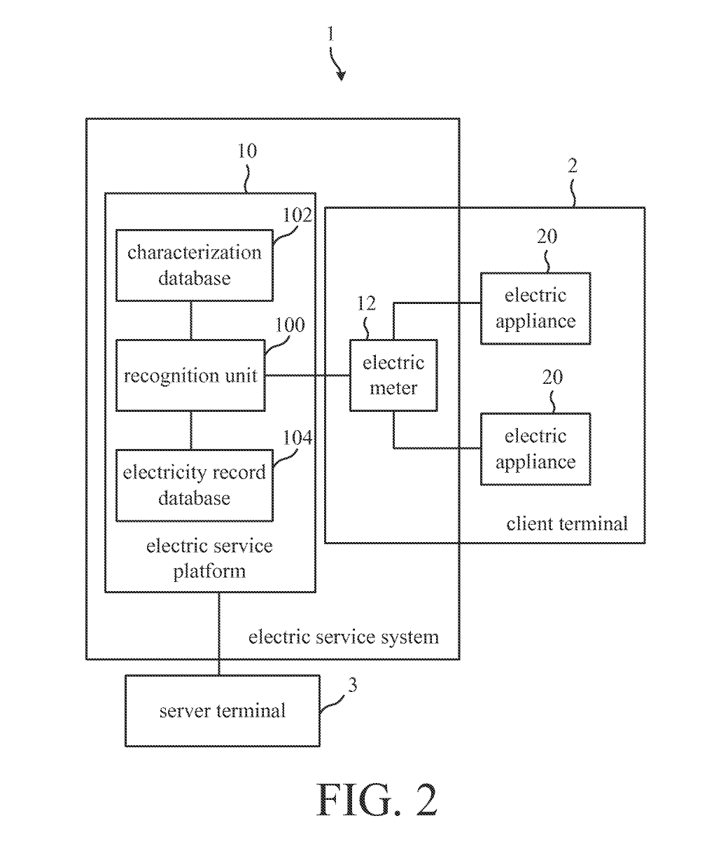

Please refer to FIG. 2. FIG. 2 is a schematic diagram illustrating an electric service platform according to the embodiment of FIG. 1. As shown in FIG. 2, the electric service platform 10 can comprise a recognition unit 100, a characterization database 102, and an electricity record database 104. The recognition unit 100 is connected to the electric meter 12 which is connected with at least one electric appliance 20 of the client terminal 2 so as to receive the electric record. In this embodiment, the electric meter 12 is connected with two electric appliances 20, but in actual application it is not limited to be this. Furthermore, the electric meter 12 can be configured on the client terminal 2 and connected to other elements of the electric service platform 10 through cable or wireless transmission.

Additionally, the recognition unit 100 can further recognize the at least one electric appliance 20 according to the electric record and the characterization data stored in a characterization database 102, wherein the characterization database is connected to the recognition unit. Since the electric meter 12 may be connected with more than one electric appliance 20, the recognition unit 100 can identify the type of the electric appliances according to the characterization data stored in a characterization database 102. To be more precise, the characterization data can comprise a variety of appliance names, power consumptions, or other recognition features of electric appliances 20. In actual application, the characterization database 102 can be built by gathering the characterization data according to at least one of user's feedback, offline build, network auto search, and statements of electric appliance.

After recognizing the electric appliances 20 by the recognition unit 100, the electric record and the recognition results can be stored in the electricity record database 104, so as to provide related information for the server terminal 3.

In the embodiment, the electricity record database 104 is connected to a recognition unit 100 for receiving and storing the electric record and the recognition results. However, in another embodiment, the electricity record database 104 can be connected to an electric meter directly, and obtain the electric record sensed by the electric meter. For example, if a first electric meter is connected to a plurality of electric appliances 20, the recognition unit 100 can identify the type of the electric appliances 20 and further to store the electric record and the recognition results in the electricity record database 104; if a second electric meter is connected to an electric appliances 20, the electricity record database 104 can be connected to an electric meter directly, and the electric record can be stored in the electricity record database 104.

In actual application, the electricity record database 104 can also store the failure record, the maintenance record, the usage condition, or the related marketing information of the electric appliances 20 at the client terminal 2. Subsequently, the electric service platform 10 can provide the information mentioned above for the server terminal 3, and then, the server terminal 3 can provide a suitable service item for the client terminal 2. On the other hand, the information mentioned above can also be provided to the client terminal 2, and thus, the client terminal 2 can know the domestic electricity consumption of each electric appliance and the detailed information of electricity bill. Therefore, the present invention can help every client terminal 2 to use the electric appliances 20 more efficiently, and further to save energy and prevent accidents for safety.

In this embodiment, the electric meter 12 is configured on the client terminal 2, so as to sense and obtain the electric record of the electric appliances 20, that is to say, the electric service platform 10 can be configured on other locations. For example, the recognition unit 100, the characterization database 102, and the electricity record database 104 of the electric service platform 10 can be configured on cloud server, and connected with the electric meter 12 through internet. Accordingly, the client terminal 2 only needs to install electric meters 12, and the server terminal 3 can disseminate advertisements or discounts on the electric service platform 10. Therefore, the installation expenses of the electric meter 12 can be afforded through the advertising expenses of the server terminal 3; that is to say, customers can install electric meters 12 without extra charge, so as to increase the popularity of the electric meters 12.

The electric service platform 10 can be configured on the server between the client terminal 2 and the server terminal 3, for serving as a communication medium therebetween. In other words, the electric service system 1 can obtain the information of client terminal 2 and server terminal 3 simultaneously, and further to transmit the information to each other by network or other manners. Furthermore, the server terminal 3 in the embodiments described previously can comprise (including but not limited to) electrical equipment supplier, security workstation, fire protection system, or other security protection systems.

More precisely, the electric service platform 10 can provide the electric record or the electric information of the client terminal 2 for the security protection systems mentioned above, and the security protection systems can diagnose which electric appliances are malfunctioned and further to provide maintenance service for the client terminal 2 forwardly.

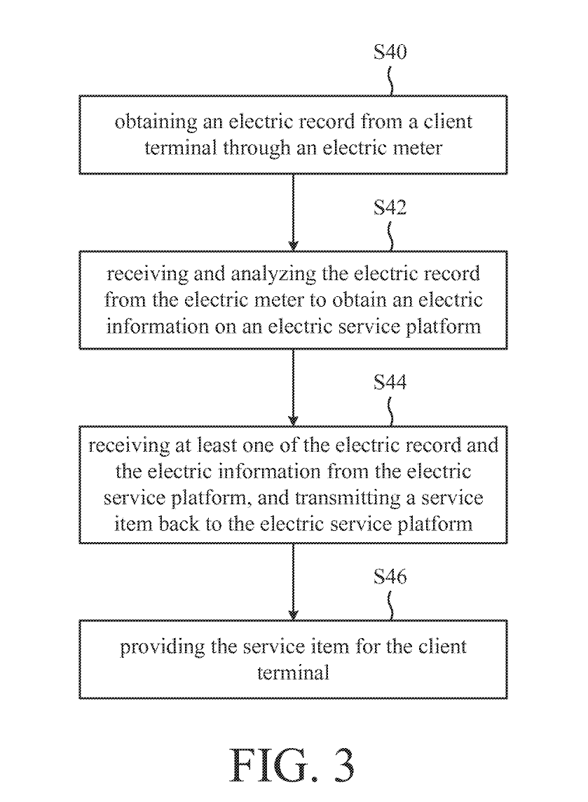

Please refer to FIG. 1 and FIG. 3. FIG. 3 is a flowchart illustrating a method for providing electric service according to another embodiment of the invention. As shown in FIG. 3, the method for providing electric service comprises following steps: step S40: obtaining an electric record from a client terminal 2 through an electric meter 12; step S42: receiving and analyzing the electric record from the electric meter 12 to obtain an electric information on an electric service platform 10; subsequently, step S44: receiving at least one of the electric record and the electric information from the electric service platform 10, and transmitting a service item back to the electric service platform 10; afterward, step S46: providing the service item for the client terminal 2.

According to this embodiment, each electric record of the client terminal 2 can be obtained by the electric meter 12, and then be received and analyzed by the electric service platform 10. After that, the server terminal 3 can provide a suitable service item for the client terminal 2 in accordance with the electric information. In the embodiment, the client terminal 2 can be general households or companies, and the server terminal 3 can be electrical equipment suppliers, security workstations, fire protection systems, or other security protection systems. To be noticed, the present invention is not limited to the embodiment described herein.

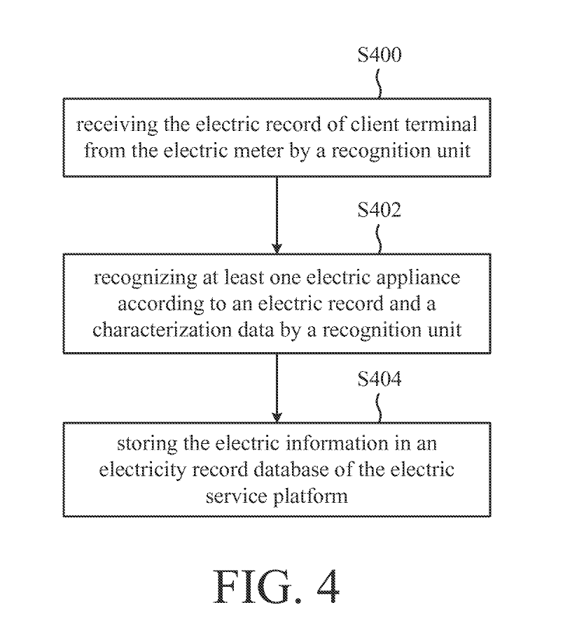

Please refer to FIG. 1 and FIG. 4 simultaneously. FIG. 4 is a flowchart illustrating the detailed steps for obtaining the electric information from the electric service platform according to the method for providing electric service of FIG. 3. The method of the embodiment can be performed with the electric service platform 10 of FIG. 2. As shown in FIG. 4, the method for providing electric service further comprises following steps: at step S400, a recognition unit 100 receives the electric record of electric appliances 20 of client terminal 2 from the electric meter 12; subsequently, step S402 is to recognize at least one electric appliance 20 according to an electric record and a characterization data by a recognition unit 100; and then, step S404 is to store the electric information in an electricity record database 126 of the electric service platform 10. With these detailed steps S400 to S404 described above, the electric service platform 10 can receive and analyze the electric record to obtain an electric information at step S42.

To be more precise, the electric information comprises the electric record and the recognition results of the at least one electric appliance 20. Wherein, the recognition results of the at least one electric appliance 20 comprises category identification and type recognition. Moreover, the electricity record database 104 can also store the failure record, the maintenance record, the usage condition, or the related marketing information of the electric appliances 20 at the client terminal 2.

According to the above, the invention is to provide an electric service system and a method for providing electric service which enables the server terminal to provide customized service for the client terminal according to the electric information of the client terminal. Therefore, the server terminal can provide services for the customers forwardly.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electric service system for a server terminal to provide a service item for a client terminal, the system comprising:
an electric meter, configured on the client terminal and connected to at least one electric appliance, and used for obtaining an electric record of the at least one electric appliance; and
an electric service platform, connected to the electric meter and the server terminal so as to receive and analyze the electric record from the electric meter to obtain an electric information, and then offer the server terminal at least one of the electric record and the electric information;
wherein the electric service platform can receive the service item from the server terminal, and then provide the service item to the client terminal,

2. The electric service system of claim 1, wherein the electric service platform comprises:
a recognition unit, connected to the electric meter for receiving the electric record, and further recognizing the at least one electric appliance according to the electric record and a characterization data;
a characterization database, connected to the recognition unit, and used for providing the characterization data; and
an electricity record database, connected to at least one of the electric meter and the recognition unit, used for storing the electric record and the recognition results of the at least one electric appliance.

3. The electric service system of claim 1, wherein the electric information comprises the electric record and the recognition results of the at least one electric appliance with the electricity record database.

4. The electric service system of claim 2, wherein the characterization data are gathered according to at least one of user's feedback, offline build, network auto search, and statements of electric appliance.

5. The electric service system of claim 1, wherein the recognition unit identifies the type of the at least one electric appliance according to the electric record and the characterization data.

6. A method for providing electric service, comprising:
obtaining an electric record of at least one electric appliance from a client terminal through an electric meter;
receiving and analyzing the electric record from the electric meter to obtain an electric information on an electric service platform;
receiving at least one of the electric record and the electric information from the electric service platform to a server terminal, and transmitting a service item back to the electric service platform; and
providing the service item for the client terminal.

7. The method for providing electric service of claim 6, further comprising:
recognizing at least one electric appliance according to an electric record and a characterization data by a recognition unit of the electric service platform; and
storing the electric information in an electricity record database of the electric service platform;
wherein the electric information comprises the electric record and the recognition results of the at least one electric appliance.

8. The method for providing electric service of claim 7, further comprising:
obtaining the characterization data from the characterization database, and recognizing at least one electric appliance according to an electric record and a characterization data by the recognition unit.

9. The method for providing electric service of claim 8, wherein the characterization data are gathered according to at least one of user's feedback, offline build, network auto search, and statements of electric appliance.

10. The method for providing electric service of claim 7, further comprising:
identifying the type of the at least one electric appliance according to the electric record and the characterization data by the recognition unit.
